(19) United States
(12) Patent Application Publication
(10) Pub. No.: US 2005/0282563 A1
(43) Pub. Date: Dec. 22, 2005

(54) Message recognition and display system and method for a mobile communication device

(75) Inventor: Yavor Eliad Wardimon, Binyamina (IL)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/872,576

(22) Filed: Jun. 17, 2004

(51) Int. Cl. H04Q 7/20

(52) U.S. Cl. 455/466; 455/412.1

(57) ABSTRACT

A method of displaying messages received by a mobile communication device is provided. The method comprises applying an identifying style to a message received by the mobile communication device in accordance with a message attribute associated with the message, wherein the message attribute identifies a category to which the message belongs; and grouping the message with other received messages that are associated with the same message attribute.

### BACKGROUND

1. Field of Invention

The present invention relates generally to message recognition in a mobile communication device and, more particularly, to a system and method for message recognition and display in accordance with defined message categories.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

In addition to voice communication, mobile devices are also used to communicate text messages over mobile communication networks. Text messages are typically transmitted and received via a text messaging service such as an instant messenger (IM) or a short messaging service (SMS). Other types of media (e.g., audiovisual content) can be also transmitted using messaging protocols, such as multimedia messaging service (MMS).

Depending on the level of activity of a mobile user, multitudes of messages may be transmitted to a user's mobile communication device in a short span of time. These messages may include audio, video, text, image, or other media content. Because of the limited functionality and limited display capabilities of mobile devices, viewing and distinguishing among a great many number of received messages can prove difficult. This can add to user frustration and unintended errors in message review and message handling.

For example, if the user cannot easily distinguish between the messages received, there is a probability that the user will be unable to recognize an important message or accidentally delete the message. It would be useful to display messages to the user in a proper order or format, so that the user can easily distinguish between them.

### SUMMARY

The present disclosure is directed to a system and corresponding methods that facilitate recognition and display of messages received by a mobile device.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method of distinguishing messages forwarded to a mobile communication device is provided. The method comprises processing a first message forwarded to the mobile communication device to determine a message category associated with the first message; and applying a first identifying style to the first message, if the first message is associated with a first message category.

In accordance with one aspect of the invention, the method further comprises processing a second message forwarded to the mobile communication device to determine the message category associated with the second message; and applying a second identifying style to the second message, if the second message is associated with the second message category, wherein the second identifying style is different from the first identifying style to visually distinguish the first message from the second message.

The first identifying style visually distinguishes the first message from a second message received by the mobile communication device. The first identifying style may be applied to a title of the first message, such that the title of the first message is displayed in a list of received messages implemented on the mobile communication device.

In one embodiment, application software executed on the mobile communication device performs at least one of the processing and applying steps above. In another embodiment, application software is executed on a computing system of a service provider connected to the mobile communication device and performs at least one of the processing and applying steps.

In accordance with yet another aspect of the invention, a method of displaying messages received by a mobile communication device is provided. The method comprises applying an identifying style to a message received by the mobile communication device in accordance with a message attribute associated with the message, wherein the message attribute identifies a category to which the message belongs; and grouping the message with other received messages that are associated with the same message attribute. A user can define one or more categories of messages by way of interacting with the mobile communication device.

In one embodiment, a system for displaying messages received by a mobile communication device comprises means for applying an identifying style to a message received by the mobile communication device in accordance with a message attribute associated with the message, wherein the message attribute identifies a category to which the message belongs; and means for grouping the message with other received messages that are associated with the same message attribute.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment, in accordance with one or more embodiments of the invention;

FIG. 2 is a flow diagram of a method processing messages received by a mobile device for display, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for processing and formatting messages received by a mobile device, so that the messages are easily recognizable by a user.

Electronic services, services, and online services are used interchangeably herein. The services provided by the system of this invention, in one or more embodiments, are provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

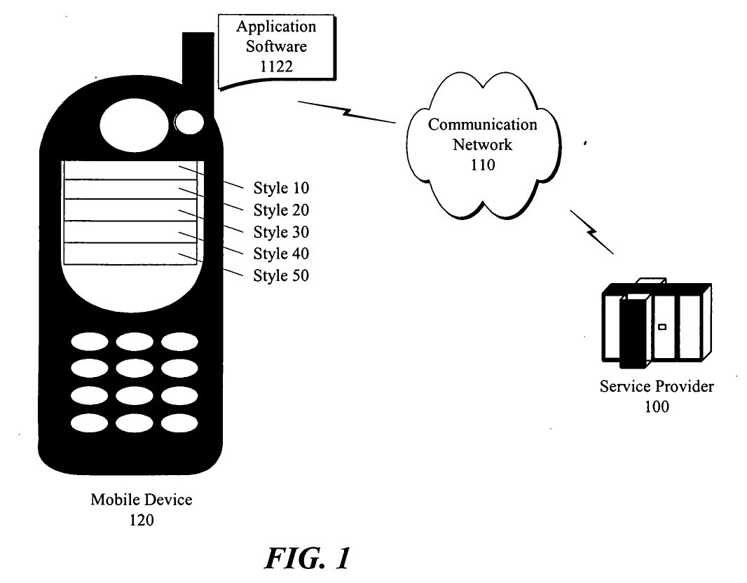

Referring to the drawings, FIG. 1 illustrates an exemplary communications environment in which the system of the present invention may operate. In accordance with one aspect of the invention, the system environment comprises a service provider 100, a communication network 110, and a mobile device 120. The service provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between service provider 100 and mobile device 120. In certain embodiments, mobile device 120 is a cellular telephone and communication network 110 is a wireless telephone network, for example. Mobile device 120, service provider 100 and communication network 110, however, may be implemented over any type of mobile, fixed, wired or wireless communication technology (e.g., landline telephony, cellular, radio, radar, infrared, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications networks that can provide a means of communication between mobile device 120 and service provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with service provider 100 to send and receive electronic packets of information, in form of electronic requests and responses. In a particular embodiment, the packets are constructed based on a messaging service, such as short messaging service (SMS), instant messenger (IM) service, or multimedia messaging service (MMS). SMS, IM and MMS enable messages comprising text or multimedia content to be communicated to mobile device 120.

SMS, IM and MMS are supported in the mobile telephony technology and other digital-based mobile communications systems. Similar to e-mail messages, short messages, instant messages and multimedia messages are stored and processed by service provider 100. That is, when a message is communicated over communication network 110 destined for mobile device 120, service provider 100 initially receives the message and forwards it to a respective mobile device 120, after processing the message.

Accordingly, in one embodiment, service provider 100 processes messages destined for one or more mobile devices 120. In certain embodiments, service provider 100 is a back end server that forwards messages to a network address (e.g., IP address) or a phone number associated with mobile device 120. In addition to text messages, service provider 100, in one embodiment, also processes messages including audio/visual content and forwards the messages to the appropriate destinations.

In one embodiment, service provider 100 is a wireless communications service provider (e.g., Sprint, AT&T, Verizon, etc.). In embodiments of the invention that are implemented using IM technology, for example, service provider 100 may comprise America On Line (AOL), Microsoft Network (MSN) and Yahoo!. Depending on implementation, application software 1122 is executed on either service provider 100 or mobile device 120 (or on a distributed environment comprising service provider 100 and mobile device 120) to process messages directed to mobile device 120.

More particularly, in accordance with one aspect of the invention, application software 1122 is installed or executed on one of mobile device 120, service provider 100, a third party portal, or a combination of said systems to recognize messages destined for mobile device 120 as belonging to defined categories. After application software 1122 determines the categories to which the messages belong, application software 1122 then causes mobile device 120 to display the messages in a particular visual format according to the respective categories.

As used herein, the terms mobile device, third party portal, service provider and communication network are to be viewed as designations of one or more computing environments that comprise application, client or server software for servicing requests submitted by respective software included in devices or other computing systems connected there to. These terms are not to be otherwise limiting in any manner. Application software 1122, for example, may be comprised of one or more modules that execute on one or more computing systems, as described in further detail below.

In one embodiment, application software 1122 is implemented to allow a user to define one or more categories of messages. The various categories may be defined in accordance with the degree of importance associated with each message, for example. Thus, messages that are marked “urgent” (e.g., include an embedded “urgent” attribute) may fall in a first category. Other categories may be defined based on the origination source of the messages, for example. Thus, messages transmitted from an account belonging to the user's spouse, children, parents, or siblings may fall in a second category, for example.

A third category may define messages that are received from professional acquaintances (i.e., business contacts, employees, supervisors, etc.), for example, based on a message attribute or origination source identifier included in the message. Thus, multiple message categories may be defined based on the origination address of the messages or an embedded identifier in the message, for example, that indicates that the message is urgent or that the message was forwarded from a particular entity or individual.

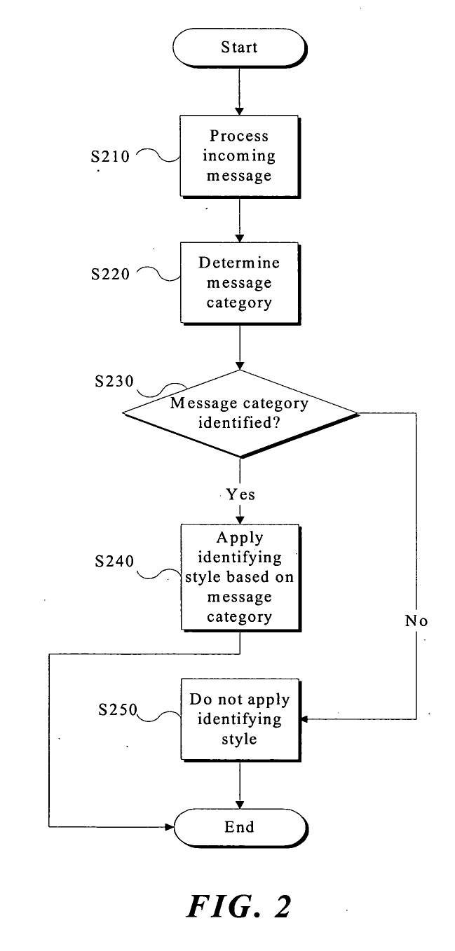

Referring to FIGS. 1 and 2, in accordance with one aspect of the invention, application software 1122 or a component thereof is executed on service provider 100 or mobile device 120, or both, to process incoming messages destined for mobile device 120 (S210). When a message is received, application software 1122 processes the message to determine a message category (S220). That is, application software 1122 processes the message to determine if a message attribute (e.g., embedded identifier, flag, origination source, source number, keyword, etc.) identifies the message as belonging to a predefined category.

It is noteworthy that the predefined categories, as indicated herein, may be programmed into mobile device 120 by way of a user interacting with mobile device 120. That is, application software 1122 may provide the user with interactive menus that would allow the user to define a series of categories. Alternatively, one or more of the categories may be preprogrammed at the time of manufacture. In either scenario, if a message category is identified (S230), then application software 1122 applies an identifying style to the message based on the corresponding category (S240). Otherwise, no identifying style is applied to the message (S250).

Depending on implementation, an identifying style may be applied to one or more segments of the message (e.g., body, title, etc.). In one embodiment, the identifying style is applied to the title of the message, such that when the user views a list of the received messages, then the stylized title stands out from the other message titles. Thus, referring to FIG. 1, if for example each one of the messages 1 through 5 received by mobile device 120 belongs to a different message category, then styles 10 through 50, as shown, will be applied to message titles 1 through 5. Since each style conveys a particular meaning to the user, the user can easily determine the category to which a message belongs without having to review its content or other related information.

Color-coding and other formatting schemes may be employed to distinguish one style from another. For example, a first style may apply the color blue to identify a message associated with a first category (e.g., family). A second style may apply the color red to identify a message associated with a second category (e.g., urgent). Other styling techniques may comprise application of different fonts, sizes, backgrounds, images, and indicia to identify and distinguish messages in different categories.

In accordance with one embodiment, application software 1122 groups messages in same or similar categories together automatically. Advantageously, this grouping approach makes is easier for a user to view and respond to the received messages because messages in same or similar categories are illustrated in the same display area. Alternatively, application software 1122 may provide an option to the user to interact with mobile device 120 to manually group or otherwise manipulate the received messages according to their respective categories.

For example, a user may interact with mobile device 120 to arrange messages in the urgent category to be displayed on the top of the list and grouped in a certain order with respect to the level of urgency. Or, for example, messages that fall in the “family” category may be grouped together and displayed in association with a particular image (e.g., picture of the user's home) so that the user upon viewing the messages can instantly identify the group of messages received from family members. In other embodiments, a user may interact with a user interface menu to create a file system with folders for each defined category, such that received messages can be either automatically or manually stored in the corresponding folders according to message category.

The formatting schemes and embodiments defined above are for illustration purposes and by way of example. Thus, one of ordinary skill in the relevant art would appreciate that other formatting schemes and identifying techniques may be implemented to define and distinguish one or more categories of messages in accordance with user preference. Application software 1122, in a preferred embodiment, allows the user to define the particular categories and the corresponding styling attributes and is embedded or installed on mobile device 120, or other systems connected to it, such as service provider 100, or a PMG server.

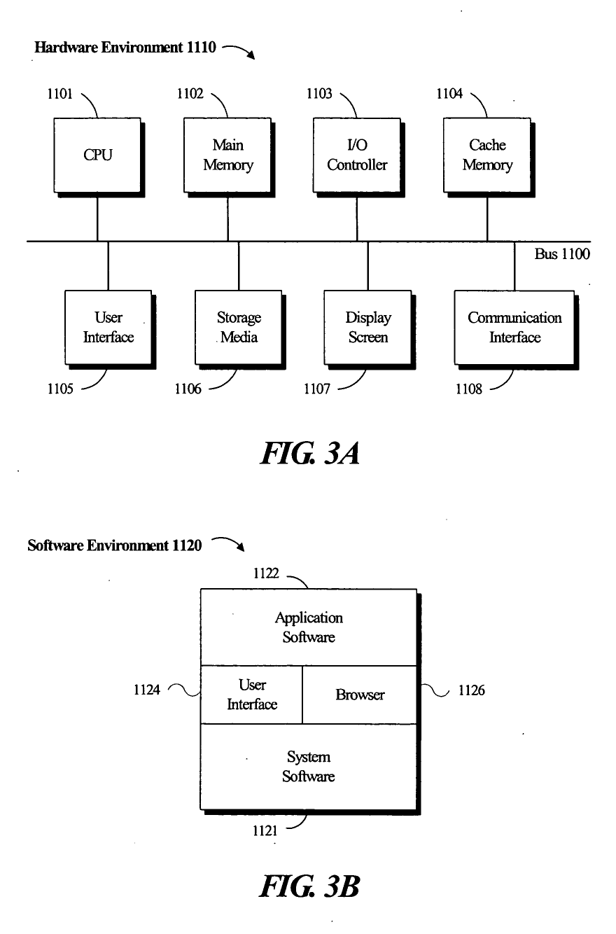

In one or more embodiments of the system, service provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In embodiments of the invention, system and application software are implemented and executed on one or more hardware environments to accommodate recognition and display of received messages in accordance with predefined categories.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, or an integrated services digital network (ISDN) card, etc.), and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile device 120 may be a PMG phone or equivalent.

In embodiments of the system, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Qualcomm, Texas Instruments, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on service provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate recognizing and displaying messages received by a mobile device 120 in accordance with predefined categories. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of distinguishing messages forwarded to a mobile communication device, the method comprising:
processing a first message forwarded to the mobile communication device to determine a message category associated with the first message; and
applying a first identifying style to the first message, if the first message is associated with a first message category.

2. The method of claim 1, further comprising:
processing a second message forwarded to the mobile communication device to determine the message category associated with the second message; and
applying a second identifying style to the second message, if the second message is associated with the second message category, wherein the second identifying style is different from the first identifying style to visually distinguish the first message from the second message.

3. The method of claim, 1, wherein the first identifying style visually distinguishes the first message from a second message received by the mobile communication device.

4. The method of claim 1, wherein the first identifying style is applied to a title of the first message.

5. The method of claim 4, wherein the title of the first message is displayed in a list of received messages implemented on the mobile communication device.

6. The method of claim 1, wherein application software executed on the mobile communication device performs at least one of the processing and applying steps.

7. The method of claim 1, wherein application software executed on a computing system of a service provider connected to the mobile communication device performs at least one of the processing and applying steps.

8. The method of claim 1, wherein the message category is determined based on a message attribute associated with the message.

9. The method of claim 8, wherein the message attribute is included in the message.

10. The method of claim 9, wherein the message attribute comprises at least one of an identifier, a flag, an origination source, a source number, and a keyword.

11. A method of displaying messages received by a mobile communication device, the method comprising:
applying an identifying style to a message received by the mobile communication device in accordance with a message attribute associated with the message, wherein the message attribute identifies a category to which the message belongs; and
grouping the message with other received messages that are associated with the same message attribute.

12. The method of claim 11, wherein a user defines one or more categories of messages by way of interacting with the mobile communication device.

13. A system for displaying messages received by a mobile communication device, the system comprising:
means for applying an identifying style to a message received by the mobile communication device in accordance with a message attribute associated with the message, wherein the message attribute identifies a category to which the message belongs; and
means for grouping the message with other received messages that are associated with the same message attribute.
